(19) United States
(12) Patent Application Publication
(10) Pub. No.: US 2014/0246297 A1
(43) Pub. Date: Sep. 4, 2014

(54) PRESS KEY DEVICE

(71) Applicant: CHANGSHU SUNREX TECHNOLOGY CO., LTD., Changshu (CN)

(72) Inventor: Qing ZHANG, Changshu (CN)

(73) Assignee: Changshu Sunrex Technology Co., Ltd., Changshu (CN)

(21) Appl. No.: 13/782,030

(22) Filed: Mar. 1, 2013

(51) Int. Cl. H01H 9/20

(52) U.S. Cl. CPC H01H 9/20
USPC 200/318.2

(57) ABSTRACT

A press key device includes: a key cap, a base plate, a frame, and a restoring unit. The key cap includes a cap portion and a fin portion protruding from the cap portion. The base plate is disposed under the key cap and is formed with a first perforation which has opposite first and second ends in a first horizontal direction. The frame is disposed on the base plate and has a frame portion and a groove which has a limit groove portion. The frame is movable from a first position to a second position and further to a third position so that the fin portion is retained in the limit groove portion to restrain downward movement of the key cap.

### BACKGROUND OF THE INVENTION

1. Field of the Invention

This invention relates to a press key, more particularly to a press key device capable of being locked.

2. Description of the Related Art

When a user of a computer temporarily leaves the computer, data stored in the computer might be exposed to potential threats, such as being altered due to an unintentional input through a press key device. Therefore, as an input device in communication with the computer, the press key device is required to be locked so as to prevent unintentional inputs.

Besides, the trend toward size reduction in computers should also be considered during the design of the press key device to enhance portability of computers. Therefore, how to reduce the overall height of the press key device when the same is under an un-used state (e.g., the press key device is usually not in use during transport) is a subject of endeavor.

### SUMMARY OF THE INVENTION

Therefore, an object of the present invention is to provide a press key device that can overcome the aforesaid drawbacks associated with the prior art.

Accordingly, a press key device of this invention comprises:

a key cap including a cap portion and a fin portion protruding from the cap portion;

a base plate disposed under the key cap and formed with a first perforation which has opposite first and second ends in a first horizontal direction;

a frame disposed on the base plate and having:
a frame portion that is formed with a through hole for receiving the cap portion of the key cap,
a groove that is in spatial communication with the through hole, that is formed in a lower surface of the frame portion for receiving the fin portion of the key cap, and that has a main groove portion and a limit groove portion extending in the first horizontal direction from a top end of the main groove portion and having a width in a top-down direction smaller than that of the main groove portion, and
a first protrusion that protrudes from the lower surface of the frame portion and that is insertable into the first perforation,
wherein the frame is downwardly movable by a first distance together with the key cap with the fin portion of the key cap being retained in the top end of the main groove portion of the groove from a first position, where the frame is away from the base plate, to a second position, where the frame portion is in contact with the base plate and where the first protrusion is extended into the first perforation of the base plate, and
wherein the frame is further movable relative to the key cap in the first horizontal direction from the second position to a third position, where the first protrusion engages the second end of the first perforation and where the fin portion is retained in the limit groove portion so that downward movement of the key cap is restrained; and

a restoring unit disposed within the through hole of the frame and secured to the cap portion of the key cap for providing an upward restoring force to the key cap, the key cap being downwardly movable relative to the frame by a second distance longer than the first distance to make contact between the restoring unit and the base plate when the frame is at the first position.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a perspective view of the preferred embodiment of a press key device according to this invention;

FIG. 2 is an exploded perspective view of the preferred embodiment;

FIG. 3 is a perspective view of a frame of the preferred embodiment;

FIG. 4 is a perspective view of an insulating layer of a base plate of the preferred embodiment;

FIG. 5 is a plan view of the preferred embodiment where the frame is at a first position;

FIG. 6 is a sectional view taken along line VI-VI in FIG. 5;

FIG. 7 is a sectional view of the preferred embodiment where a key cap is downwardly moved to a pressed position by a second distance to make contact between a restoring unit and the base plate;

FIG. 8 is a plan view of the preferred embodiment where the frame is at a second position;

FIG. 9 is a sectional view taken along line IX-IX in FIG. 8;

FIG. 10 is a plan view of the preferred embodiment where the frame is at a third position; and

FIG. 11 is a sectional view taken along line XI-XI in FIG. 10.

### DETAILED DESCRIPTION OF THE PREFERRED EMBODIMENT

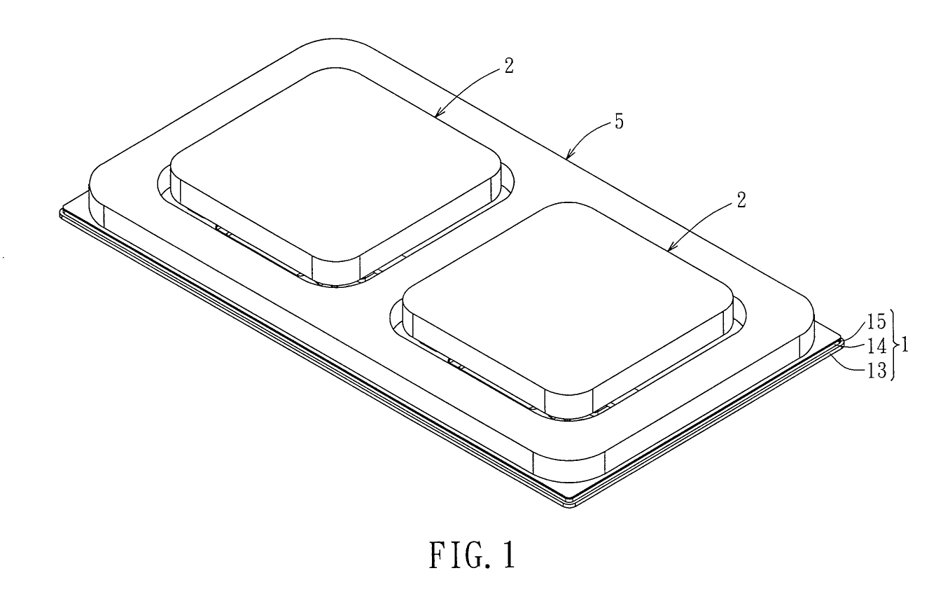

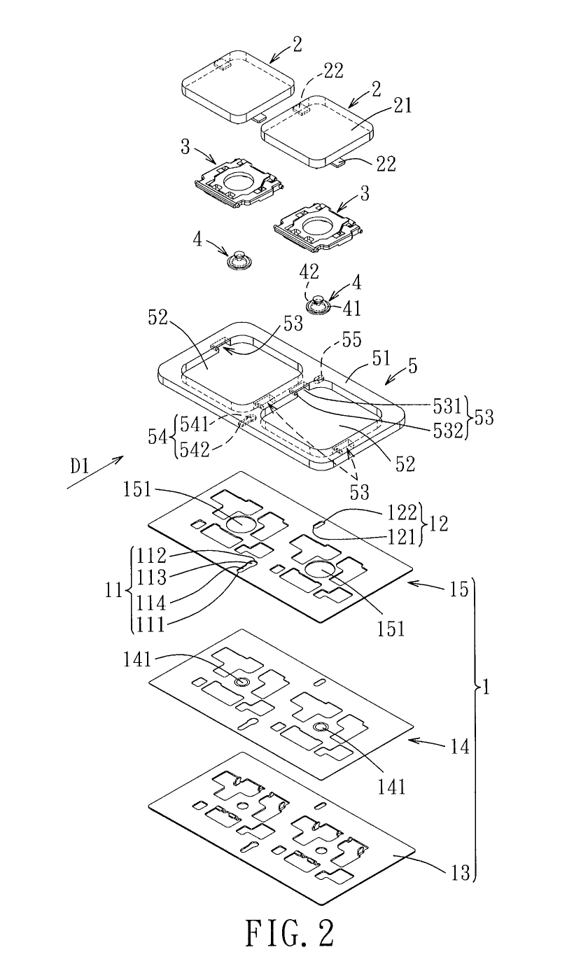

FIGS. 1 and 2 illustrate the preferred embodiment of a press key device according to this invention. The press key device comprises a base plate 1, a plurality of key caps 2, a plurality of scissors linkages 3, a plurality of restoring units 4, and a frame 5. For the sake of convenience, in this embodiment, the press key device having two key caps 2, two scissors linkages 3, and two restoring units 4 is used for illustration. A press key device having a key cap 2, a scissors linkage 3, and a restoring unit 4 is also feasible.

As shown in FIG. 2, the base plate 1 is disposed under the key cap 2 and the frame 5, and is formed with a first perforation 11 having opposite first and second ends 111, 112 in a first horizontal direction (D1). The first perforation 11 is of a pear shape. The base plate 1 is further formed with a second perforation 12 having opposite first and second ends 121, 122 in the first horizontal direction (D1). The second perforation 12 is spaced apart from the first perforation 11 in the first horizontal direction (D1) and is generally elliptical. The base plate 1 includes a substrate 13 made of metal, a membrane circuit layer 14 disposed on the substrate 13, and an insulating layer 15 disposed between the membrane circuit layer 14 and the frame 5. The first and second perforations 11, 12 penetrate the substrate 13, the membrane circuit layer 14, and the insulating layer 15.

The insulating layer 15 is formed with two through holes 151 for allowing the restoring units 4 to respectively extend therethrough. The membrane circuit layer 14 has a top surface formed with two conductive portions 141 each of which corresponds in position to a respective one of the through holes 151 and which are used to contact the restoring units 4 to generate signals. The conductive portions 141 can be a membrane switch or another type of switch. The insulating layer 15 can be a Mylar thin film.

Each of the key caps 2 is disposed on the base plate 1 and includes a cap portion 21 and two fin portions 22 which protrude oppositely from the cap portion 21 in a second horizontal direction (D2) perpendicular to the first horizontal direction (D1). The key caps 2 can be pressed to a pressed position in a top-down direction.

Each of the scissors linkages 3 is disposed between and interconnects a respective one of the key caps 2 and the base plate 1. Each of the scissors linkages 3 is retractable when the respective one of the key caps 2 is downwardly moved.

Each of the restoring units 4 includes an arc portion 41 that is secured to the cap portion 21 of a respective one of the key caps 2, and an abutting portion 42 that extends from the arc portion 41 opposite to the cap portion 21 and that contact a respective one of the conductive portions 141 of the membrane circuit layer 14 when the respective one of the key caps 2 is at the pressed position. Each restoring unit 4 provides an upward restoring force to the respective one of the key caps 2 to keep the frame 5 away from the base plate 1.

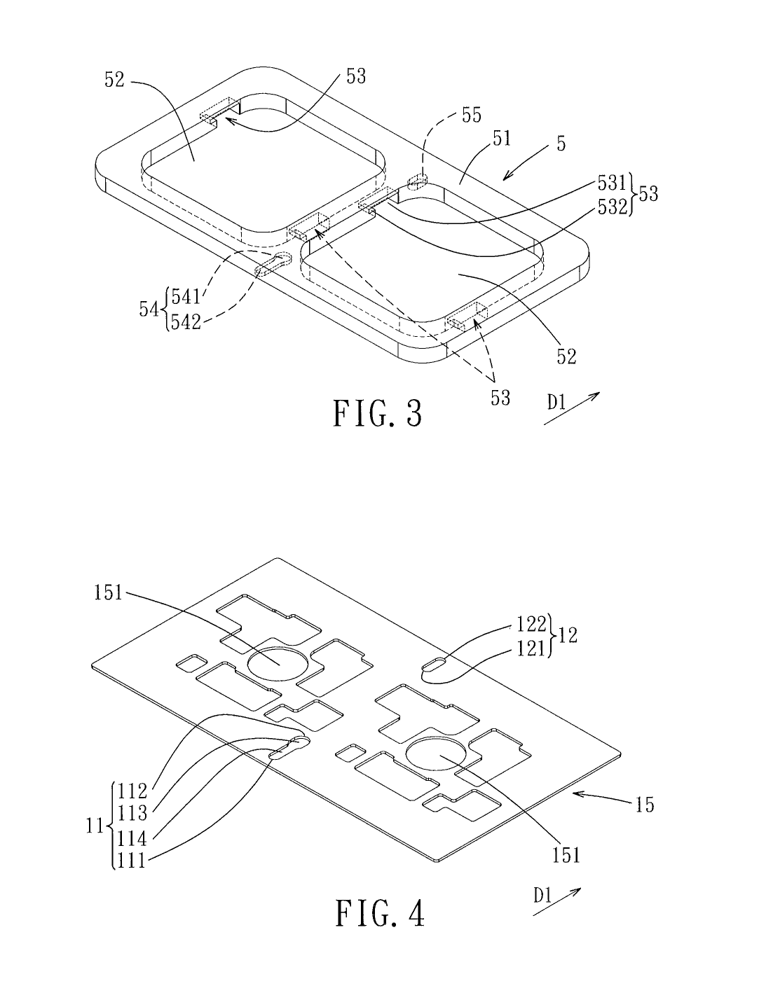

FIG. 3 is a perspective view of the frame 5.

The frame 5 is disposed on the base plate 1 and has a frame portion 51, four grooves 53, a first protrusion 54, and a second protrusion 55. The frame portion 51 is formed with two through holes 511 each for receiving the cap portion 21 of the respective one of the key caps 2, a respective one of the scissors linkages 3, and a respective one of the restoring units 4. The grooves 53 are in spatial communication with the through holes 511, and are formed in a lower surface of the frame portion 51 for respectively receiving the fin portions 22 of the key caps 2. Each of the grooves 53 has a main groove portion 531 and a limit groove portion 532 which extends in the first horizontal direction (D1) from a top end of the main groove portion 531. The limit groove portion 532 has a width in a top-down direction smaller than that of the main groove portion 531. The first protrusion 54 of the frame 5 protrudes from the lower surface of the frame portion 51 and is insertble into the first perforation 11. The second protrusion 55 protrudes from the lower surface of the frame portion 51 and is insertable into the second perforation 12. The first protrusion 54 has a head portion 541 and a stick portion 542 which extends from an end of the head portion 541 in the first horizontal direction (D1). The stick portion 542 has a maximum width in the second horizontal direction (D2) that is smaller than that of the head portion 541.

FIG. 4 is a perspective view of the insulating layer 15.

The first perforation 11 of the base plate 1 has a rounded hole part 113 and an elongated hole part 114. The rounded hole part 113 has the second end 112 of the first perforation 11. The elongated hole part 114 has the first end 111 of the first perforation 11 and is spatially communicated with the rounded hole part 113 in the first horizontal direction (D1). The elongated hole part 114 has a maximum width in the second horizontal direction (D2) smaller than that of the rounded hole part 113.

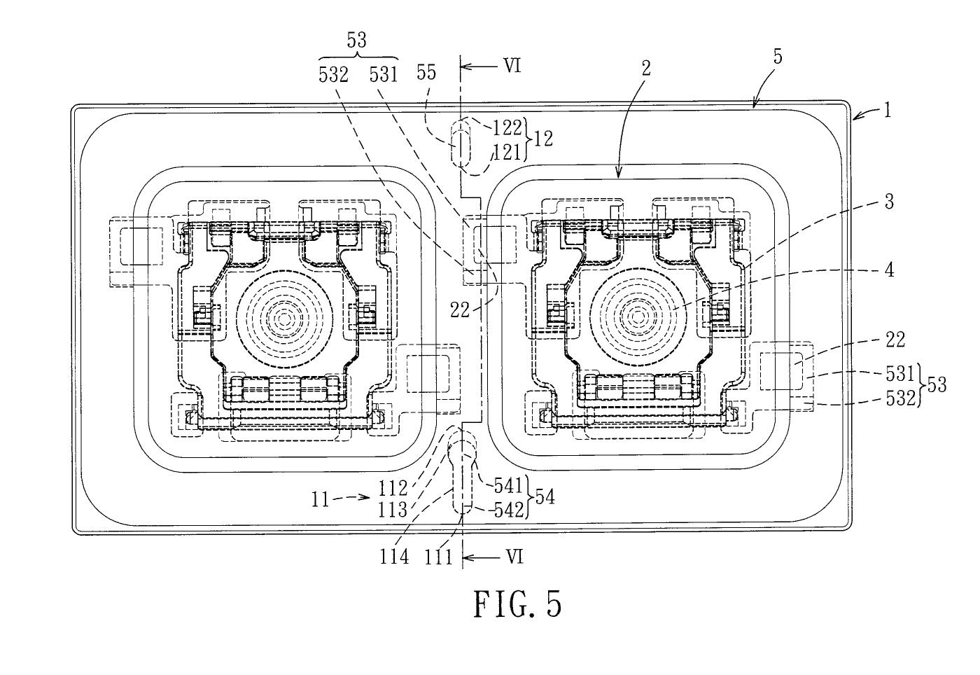

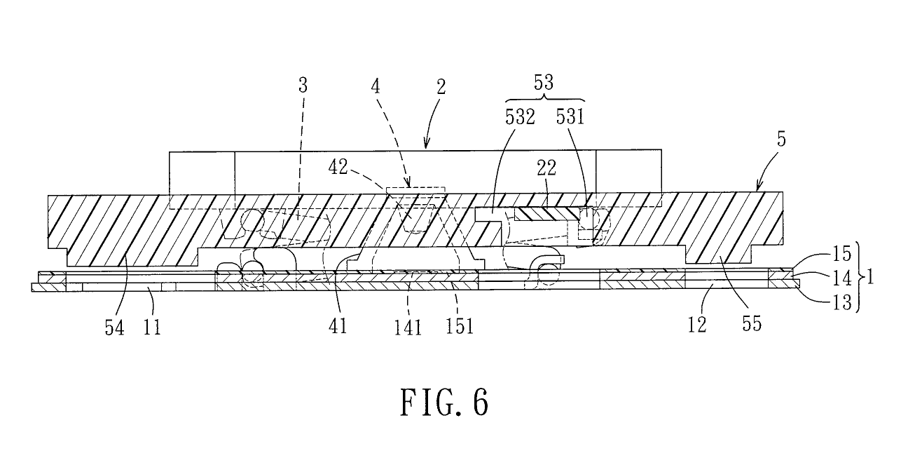

FIGS. 5 and 6 illustrate the frame 5 at a first position. When the frame 5 is at the first position, the frame 5 is away from the base plate 1 and each of the fin portions 22 is retained in the top end of the main groove portion 531 of a corresponding one of the grooves 53. When each of the fin portions 22 is retained in the main groove portion 531 of the corresponding one of the grooves 53, the key caps 2 can be freely movable in the top-down direction.

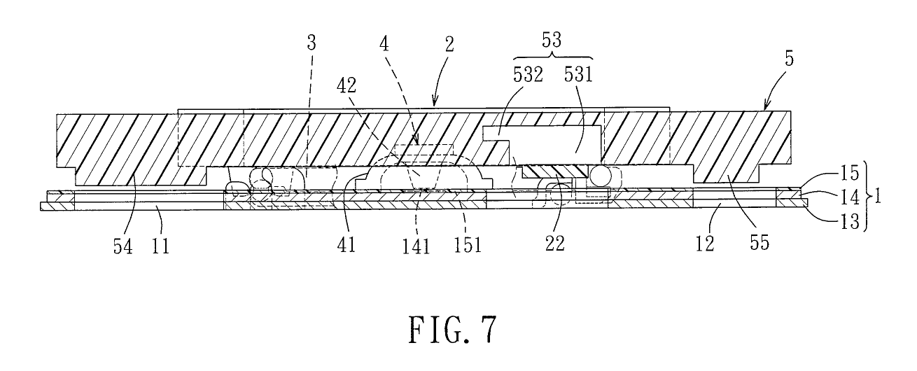

FIG. 7 is a sectional view where one of the key caps 2 is pressed to be downwardly moved to the pressed position relative to the frame 5 by a second distance.

In the pressed position, the abutting portion 42 of each of the restoring units 4 penetrates a respective one of the through holes 151 of the insulating layer 15 and contacts a respective one of the conductive portions 141 of the membrane circuit layer 14, thereby generating an electrical signal. It should be noted that, at the pressed position, the frame 5 is still at the first position.

When the press key device is intended to be locked, i.e., the abutting portions 42 of the restoring units 4 are to be prevented from making contact with the membrane circuit layer 14, the frame 5 is required to be moved from the first position to a second position and then to a third position.

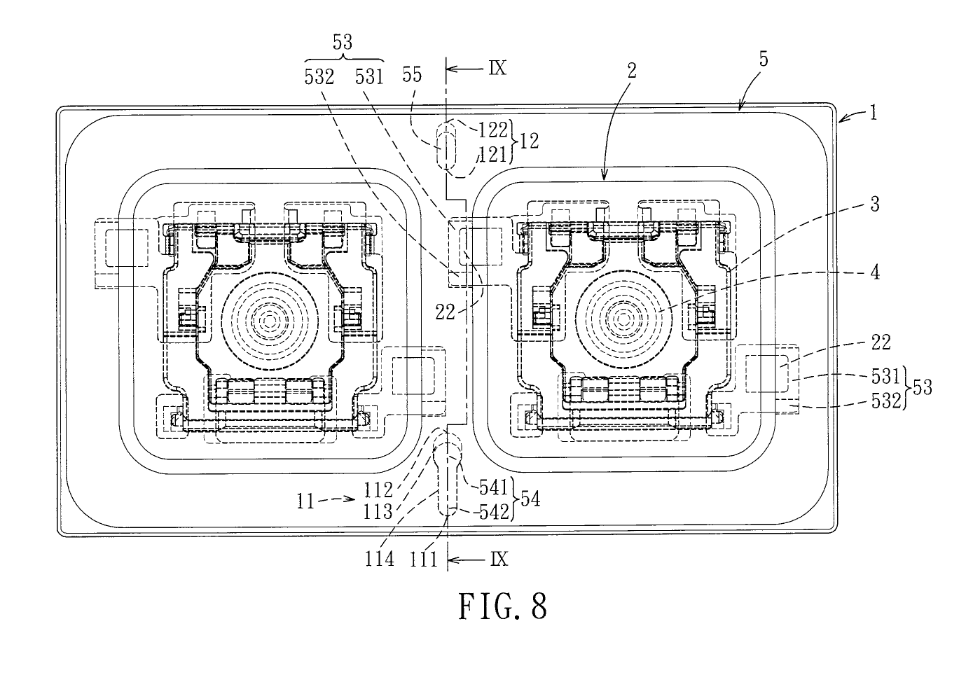

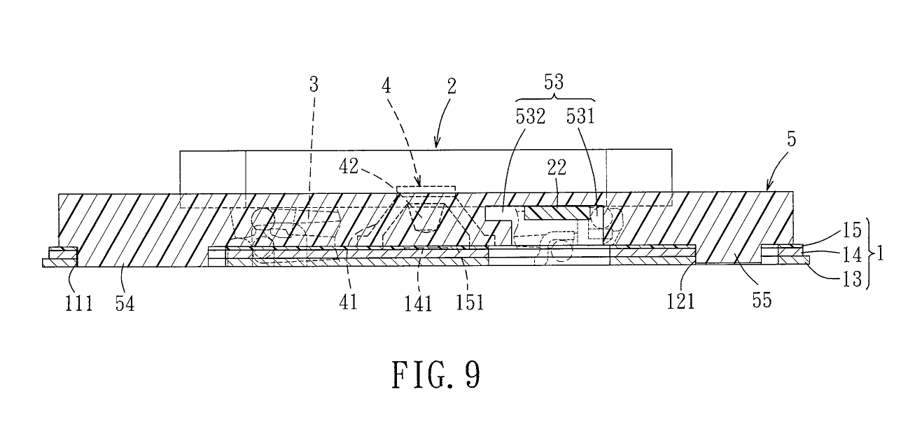

FIGS. 8 and 9 show the frame 5 at the second position.

At the second position, the frame portion 51 is in contact with the insulating layer 15 of the base plate and the first and second protrusions 54, 55 respectively extend into the first and second perforations 11, 12 of the base plate 1. At this position, the second protrusion 55 engages the first end 121 of the second perforation 12, the stick portion 542 of the first protrusion 54 engages the first end 111 of the first perforation 11, and the head portion 541 of the first protrusion 54 is adjacent to the border of the rounded hole part 113 and the elongated hole part 114. When the frame 5 is moved to the second position, the key caps 2 are moved downwardly along with the frame 5, and each of the fin protrusions 22 is still retained in the top end of the main groove portion 531 of the respective one of the grooves 53. In this embodiment, the second distance is designed to be longer than the first distance, and thus the abutting portions 42 of the restoring units 4 are spaced apart from the base plate 1 after moving the frame 1 to the second position. Thus, no electrical signal is generated.

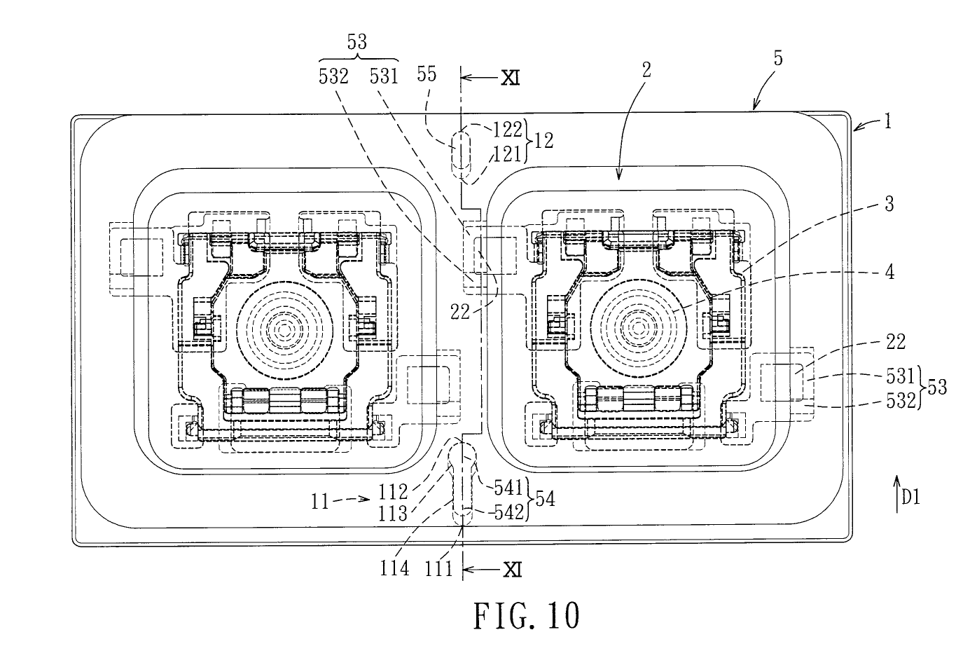

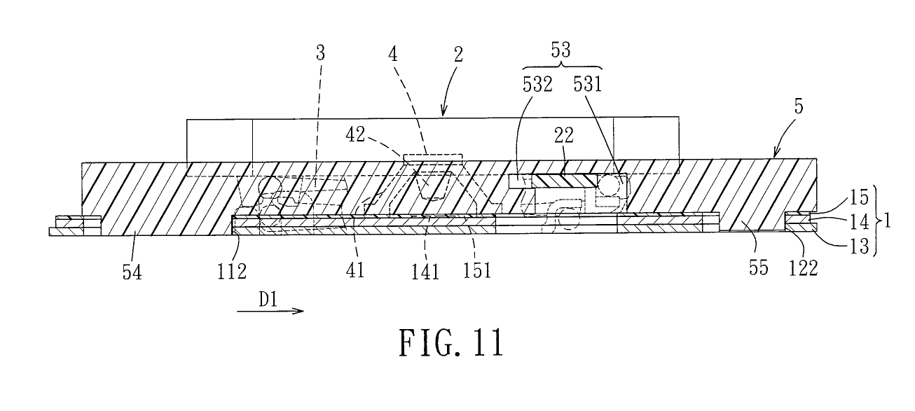

The frame 5 is then moved relative to the key caps 2 to the third position to lock the key caps 2. FIG. 10 is a plan view of the frame 5 at the third position. FIG. 11 is a sectional view taken along line XI-XI in FIG. 10.

The press key device is locked after the frame 5 is moved in the first horizontal direction (D1) from the second position to the third position where the first and second protrusions 54, 55 engage respectively the second ends 112, 122 of the first and second perforations 11, 12 and where the fin portions 22 are respectively retained in the limit groove portion 532 so that vertical movement of the key caps 2 is restrained. With the first and second protrusions 54, 55 and the first and second perforations 11, 12, the fin portions 22 can be precisely guided into the limit groove portions 532. The press key device can be unlocked by moving the frame 5 from the third position to the first position through the second position.

It should be noted that the number of the fin portions 22 is not limited to the disclosure of this embodiment, and the press key device of this invention can have the key cap 2 with only one fin portion 22.

To sum up, with the structural design of the fin portion 22 and the groove 53, the key cap 2 can be locked to prevent contact between the abutting portion 42 and the conductive portion 141 of the membrane circuit layer 14, thereby eliminating unintentional input through the press key device. Moreover, the press key device has a reduced height when the same is locked. Thus, when the press key device of this invention is applied to a laptop computer, the overall thickness of the laptop computer can be further reduced, thereby miniaturizing the laptop computer size and enhancing portability of the laptop computer.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. A press key device, comprising:
a key cap including a cap portion and a fin portion protruding from said cap portion;
a base plate disposed under said key cap and formed with a first perforation which has opposite first and second ends in a first horizontal direction;
a frame disposed on said base plate and having
a frame portion that is formed with a through hole for receiving said cap portion of said key cap,
a groove that is in spatial communication with said through hole, that is formed in a lower surface of said frame portion for receiving said fin portion of said key cap, and that has a main groove portion and a limit groove portion extending in the first horizontal direction from a top end of the main groove portion and having a width in a top-down direction smaller than that of said main groove portion, and
a first protrusion that protrudes from said lower surface of said frame portion and that is insertable into said first perforation,
wherein said frame is downwardly movable by a first distance together with said key cap with said fin portion of said key cap being retained in said top end of said main groove portion of said groove from a first position, where said frame is away from said base plate, to a second position, where said frame portion is in contact with said base plate and where said first protrusion is extended into said first perforation of said base plate, and
wherein said frame is further movable relative to said key cap in the first horizontal direction from the second position to a third position, where said first protrusion engages said second end of said first perforation and where said fin portion is retained in said limit groove portion so that downward movement of said key cap is restrained; and
a restoring unit disposed within said through hole of said frame and secured to said cap portion of said key cap for providing an upward restoring force to said key cap, said key cap being downwardly movable relative to said frame by a second distance longer than the first distance to make contact between said restoring unit and said base plate when said frame is at the first position.

2. The press key device of claim 1, wherein said base plate is further formed with a second perforation having opposite first and second ends in the first horizontal direction, said frame further including a second protrusion that protrudes from said lower surface of said frame portion and that is insertable into said second perforation, said second protrusion being extended into said second perforation when said frame is at the second position, and engaging said second end of said second perforation when said frame is at the third position.

3. The press key device of claim 1, wherein said first protrusion has a head portion and a stick portion extending from an end of said head portion in said first horizontal direction and having a maximum width in a second horizontal direction perpendicular to the first horizontal direction, said maximum width of said stick portion being smaller than that of said head portion, said first perforation of said base plate having a rounded hole part that has said second end of said first perforation, and an elongated hole part that is spatially communicated with said rounded hole part in said first horizontal direction, that has a maximum width in the second horizontal direction smaller than that of said rounded hole part, and that has said first end of said first perforation.

4. The press key device of claim 2, wherein said first and second perforations of said base plate are spaced apart in said first horizontal direction.

5. The press key device of claim 2, wherein said base plate includes a substrate, a membrane circuit layer disposed on said substrate, and an insulating layer disposed between said membrane circuit layer and said frame, said first and second perforations penetrating said substrate, said membrane circuit layer, and said insulating layer.

6. The press key device of claim 4, wherein said base plate includes a substrate, a membrane circuit layer disposed on said substrate, and an insulating layer disposed between said membrane circuit layer and said frame, said first and second perforations penetrating said substrate, said membrane circuit layer, and said insulating layer.

7. The press key device of claim 1, further comprising a scissors linkage interconnecting said key cap and said base plate and retractable when said keycap is downwardly moved.
